(19) United States
(12) Patent Application Publication
(10) Pub. No.: US 2005/0178697 A1
(43) Pub. Date: Aug. 18, 2005

(54) Flat mail vertical stacking aid

(76) Inventor: Michael E. Caporali, Endicott, NY (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/718,362

(22) Filed: Nov. 20, 2003

(51) Int. Cl. B07C 5/00

(52) U.S. Cl. 209/546; 209/564

(57) ABSTRACT

A mail sorting bin insert permits substantially vertical mail stacking in mail bins even when the bin is partially empty. The insert comprises a base and at least one substantially vertical support of a lightweight, strong material. The insert can be used in conjunction with automatic sorting of flat mail, and can be sized to fit in mail bins used in other automated operations.

### BACKGROUND OF INVENTION

1. Field of Invention

This invention relates to an insert for mail sorting.

2. Discussion of Related Art

Flat mail, such as magazines and newspapers, are currently stacked horizontally in flat mail trays in order of delivery (i.e., carrier sequence). Therefore, at each address, a mail carrier takes the top piece(s) of flat mail from the bin for delivery. However, because most pieces of mail do not have the same length and/or width as those of the bin, smaller pieces of mail can slide within the bin with respect to other larger pieces after being sorted, and thus fall out of carrier sequence. Even if the mail does not fall out of carrier sequence, its horizontal orientation in a mail tray can make it difficult for the carrier to read the delivery addresses immediately prior to delivery.

It is known that stacking mail vertically alleviates many of these disadvantages. One drawback associated with stacking mail vertically is that the flat mail tends to slip and/or fall when the mail bin is not full, leading to difficulties for a mail carrier. For example, when bins of vertically stacked mail are partially empty, the mail can slide down, resulting in horizontally oriented mail “face up” (i.e., with the address label showing). Alternatively, the mail could pivot with respect to the bin and fall over, resulting in horizontally oriented mail “face down” (i.e., with the address label underneath the mail piece). Additionally, the top of a piece of less rigid mail (such as a magazine) can curl over itself, thus preventing a mail carrier from observing the delivery address. Furthermore, if a piece of mail is curled over itself, its center of gravity may be displaced enough to flip the curled mail over other mail pieces, causing the mail to fall out of carrier sequence.

### SUMMARY OF INVENTION

One illustrative embodiment of the invention provides a mail sorting bin insert having a bottom defining a substantially planar surface having a length and width, wherein the length and/or width substantially corresponds to the length and/or width of a standard mail bin, and at least one support projecting upright from the bottom which is configured to support flat mail in a substantially vertical configuration.

Another illustrative embodiment provides a mail sorting bin insert having at least one substantially vertical section projecting from a substantially horizontal section, wherein the insert is sized and configured to receive flat mail from an automatic mail sorter, and the at least one substantially vertical section is configured to support flat mail in a substantially vertical orientation.

Another illustrative embodiment of the present invention includes a mail sorting bin insert having a base defining a substantially planar surface wherein the base is sized and configured to substantially cover a bottom surface of a mail sorting bin, and a plurality of substantially vertical supports attached to the base, wherein each support has a triangular-shaped cross section sized and configured to support flat mail in a substantially vertical orientation, and wherein the insert is configured to permit automatic sorting of flat mail into carrier walk sequence.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective side view of an insert according to the present invention in a mail bin with mail.

FIG. 2 is a perspective side view of an alternative embodiment of the insert according to the present invention.

FIG. 3 is a cut away side view of the insert of FIG. 1 according to the present invention in a mail bin with mail.

FIG. 4 is perspective top view of an unfolded insert according to the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

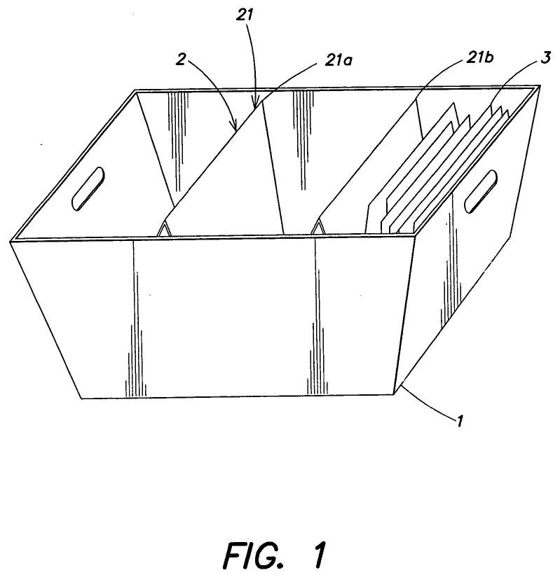

Illustrative embodiments of the present invention provide a mail bin insert which permits vertical mail stacking in mail bins. In a first illustrative embodiment, FIG. 1 shows a mail bin 1 with a removable insert 2 placed therein. As shown, the insert 2 comprises at least one substantially vertical support 21, and may comprise a plurality of substantially vertical supports 21a, 21b. Using the insert 2, flat mail 3 can be supported in a substantially vertical orientation by a support 21 even when the mail bin 1 is partially empty. In other words, a support 21 retains the mail 3 in a subsection of a mail bin 1, thus limiting the distance that the mail 3 can slip. Additionally, the support 21 can provide a surface for the mail 3 to lean against, thus decreasing the potential for mail to curl over itself.

Base

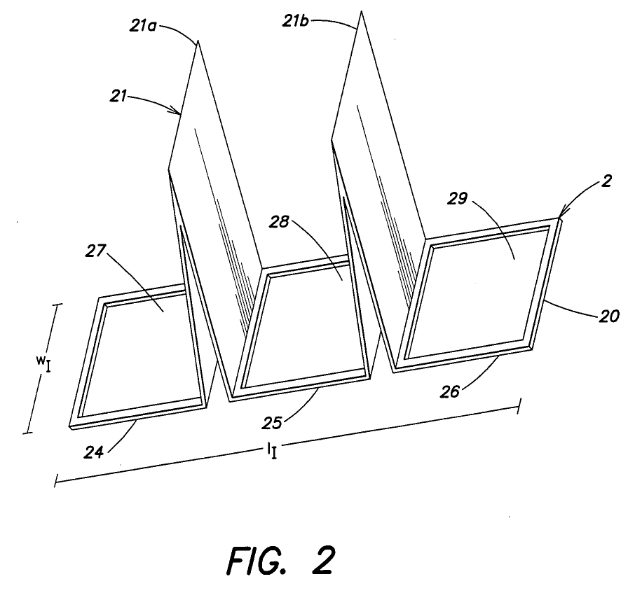

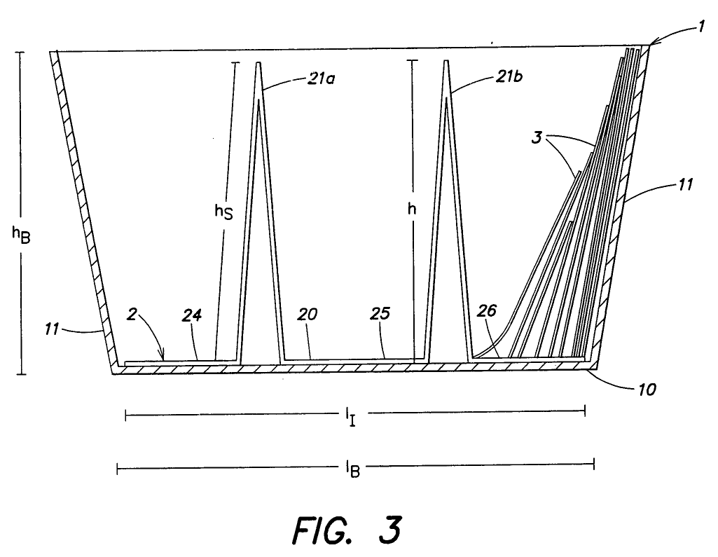

As shown in FIG. 2, the insert 2 comprises a bottom or base 20 and at least one substantially vertical support 21. In one embodiment, the bottom 20 is a substantially planar surface with a length l_{I} and width w_{I}. As shown in FIG. 3, the base 20 may be constructed to occupy at least a substantial portion of the length l_{B} of a mail bin 1. In other words, the length of the insert l_{I} may approximate the length of the mail bin l_{B}. Alternatively or additionally, the base 20 can be constructed to substantially occupy the width of a mail bin (not shown). If the length l_{I} or width w_{I} of the insert approximates the corresponding length l_{B} or width of a mail bin, the movement of the insert 2 with respect to a mail bin 1 will be substantially constrained in at least one direction when the insert 2 is placed inside the mail bin 1.

As shown, the base 20 does not have to be a single piece of material occupying a substantial portion of the bottom of the mail bin 10. Thus the base 20 may comprise one or more segments which may or may not abut one another. For example, in the embodiments shown in FIGS. 2 and 3, the base 20 may contain three substantially coplanar disjointed sections 24, 25, 26.

In addition, the base 20 does not have to comprise a solid platform. The base 20 may have one or more cut outs 27, 28, 29 (FIG. 2) in order to reduce the weight of the insert 2. The cut outs 27, 28, 29 may be sized and configured such that the mail 3 is substantially prevented from slipping under the supports 21, yet the base 20 is strong enough to prevent the insert 2 from sliding with respect to the mail bin 1. In one embodiment of the present invention, a section 24, 25, 26 may contain more than one cut out (not shown).

In another embodiment of the present invention, the base 20 may comprise at least one rod to position the supports 21 where desired with respect to the bin 1. For example, the base 20 could comprise a bar about the perimeter of the bin, thus preventing the supports 21 from moving laterally with respect to the bin 1. Alternatively, the base 20 could comprise supporting rods configured such that the ends of the rods sit in the corners of the bin. Other embodiments of the base 20 which substantially prevent the insert 2 from sliding with respect to the bin 1 will be apparent to those of skill in the art.

Supports

In one embodiment, the support 21 is attached to the base 20 such that it is oriented in an upright direction as shown in FIGS. 1 through 3. The support 21 may be substantially perpendicular to the base 20. Furthermore, in one embodiment, the support(s) 21 may separate disjointed sections of the base 24, 25, 26. Thus, the substantially vertical support 21 is configured to support mail 3 in a substantially vertical orientation when the insert 2 is placed in a mail bin 1. In use, mail 3 is placed in a bin 1 either between two adjacent supports 21a, 21b or between a support 21 and the side of the bin 11 such that it leans against either a support 21 or the side of the bin 11 as shown in FIG. 3. Mail is thus prevented from assuming a horizontal orientation because a support 21 constrains the mail from falling beyond the location of the support 21. In one embodiment, the substantially vertical support 21 may have a substantially triangular-shaped cross section, as shown in FIG. 3. However, the substantially vertical support 21 may alternatively have a rectangular-shaped cross section, a trapezoidal-shaped cross section, or a cross section of any other shape, as long as it is constructed to support mail 3 in a substantially vertical orientation.

The vertical support(s) 21 may be placed anywhere along the length of the base l_{I}. The number of vertical supports 21 may be chosen from any number of vertical supports 21, but the support(s) 21 should not be so far apart as to give insubstantial support to the vertically stacked mail 3 when the mail bin 1 is not full. With too few vertical supports 21 or with supports 21 placed too far apart, there may be insufficient support to support the mail 3 in a substantially vertical orientation when the bin 1 is not full. However, it should be noted that if there are too many vertical supports 21 or the supports 21 are too close together, less mail 3 will fit in the bin 1 because the supports themselves 21 will occupy a significant portion of the bin 1. One embodiment of the present invention contains between two and four vertical supports 21 on an insert 2.

Furthermore, as seen in FIG. 3, the support 21 can be constructed such that the height h of the support 21 approximates the height h_{B} of the mail bin 1. Additionally or alternatively, the slope height hₛ of the vertical support 21 may be configured to be at least as large as the width of standard magazines and newspapers such that the insert 21 can support a substantial portion of the width of most flat mail 3. For example, one mail bin which may be used in conjunction with the present invention is approximately 12 inches wide, 15 inches long, and 11 inches deep. Although some approximate dimensions have been described, the insert 2 can be created in any size as will be apparent to one of skill in the art. In particular, the insert 2 may be sized and configured to fit any mail bin 1, and may be chosen to fit a standard mail bin which is configured for use in other automated operations such as lidding.

Overall Configuration and Use

In one embodiment of the present invention, the insert 2 is made from a single sheet of material. Therefore, fasteners, adhesives, and alternative joining means may be unnecessary to assemble or hold the insert in its shape. For example, the insert 2 may be preformed from a single piece of material into its preconfigured three-dimensional shape.

Additionally, the insert 2 may be configured so that it could be stored in a nested or partially nested fashion when the insert 2 is not in use. For example, in the embodiment of FIG. 2, supports 21 from a plurality of inserts 2 may be aligned such that the plurality of inserts 2 can nest when stacked to conserve storage space.

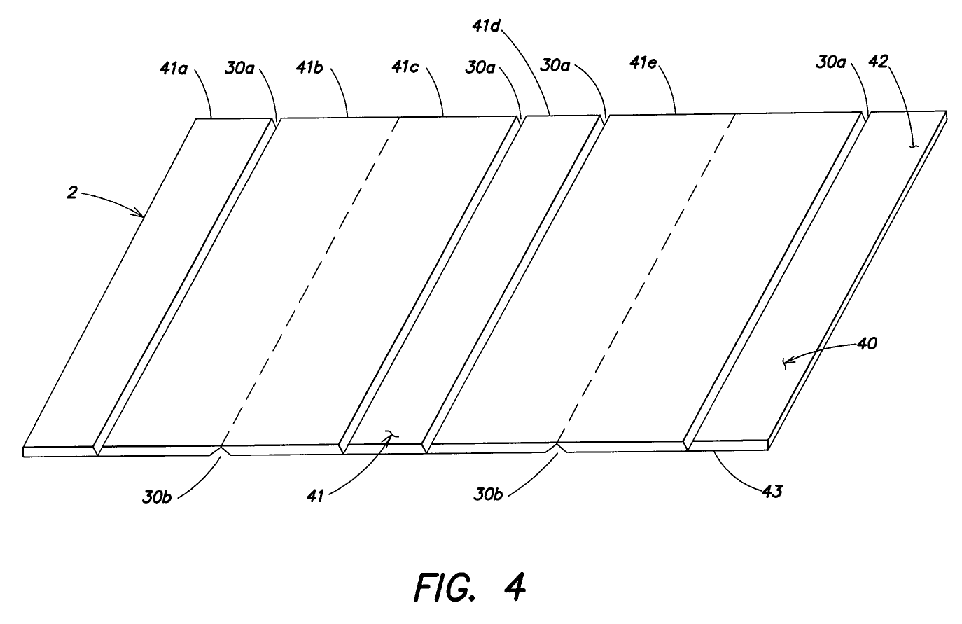

In one embodiment of the present invention, the insert 2 may be stored as a flat sheet and brought to its three-dimensional configuration only when desired. Thus, as shown in FIG. 4, an insert 2 can comprise a flat sheet 40 containing an upper surface 42, a lower surface 43, and a plurality of sections 41. Predefined fold lines 30a, 30b separate adjacent sections 41 of the flat sheet 40. At least one predefined fold line may permit folding in one direction and at least one predefined fold line may permit folding in the other direction. For example, the predefined fold lines 30a, 30b in the flat sheet 40 may be configured such that at least one fold line 30a permits rotation of one section (e.g., 41a) with respect to an adjacent section (e.g., 41b) to bring the lower surfaces of the two adjacent sections 41a, 41b closer together. Also, at least one predefined fold line 30b may permit rotation of one section (e.g., 41b) with respect to an adjacent section (e.g., 41c) to bring the upper surfaces of the adjacent sections 41b, 41c closer together. Although a single section (e.g., 41b) may have one predefined fold line on one side that permits folding in one direction 30a and a predefined fold line on the other side which permits folding in the other direction 30b, it is not necessary that each section 41 be bounded by predetermined fold lines which permit folding in different directions 30a, 30b. For example, section 41d is bordered by two predefined fold lines 30a which each permit rotation of the adjacent sections 41c, 41e in the same direction. The flat sheet 40 can then be folded at the predefined fold lines 30a, 30b to form the substantially vertical section(s) and horizontal section(s) of the insert 2.

As will be apparent to one of skill in the art, many means can be used to create predefined fold lines, such as scores, prefolded lines, perforations, and thinned material. As also apparent to one of skill in the art, the embodiment of FIG. 4 can alternatively or additionally be created by connecting different pieces of material together. For example, each panel could be composed of a different piece of material and the connections between the panels could denote the predefined fold lines. Once the insert 2 is folded into the desired shape, the insert 2 can be placed into a mail sorting bin 1 for use. The walls 11 of the mail sorting bin (shown in FIG. 3) and/or the weight of the sorted mail 3 on the insert 2 can prevent the insert 2 from assuming a flat, unfolded configuration. Other means for preventing the insert 2 from assuming a flat configuration during use will be apparent to one of skill in the art.

The insert 2 may be comprised of any lightweight material. For example, the material may comprise cardboard, plastic, wood, a composite, or other materials suitable for this application, and combinations thereof. Additionally, at least a portion of the material may be corrugated or contain a hex cell or other equivalent structure in order to reduce the weight of the insert 2. Other material choices will be apparent to those of skill in the art which would result in a lightweight insert 2 strong enough to support the weight of the mail 3 in a substantially vertical orientation.

Additionally, the base 20 may have an anti-slip coating or comprise a slip-resistant material (such as a rough and/or high friction surface). As apparent to one of skill in the art, a slip-resistant surface on the top of the insert (i.e., the surface of the insert 2 contacting mail 3) may decrease the tendency of mail 3 in the bin 1 to slip when the bin 1 is not full. Similarly, a slip-resistant surface on the bottom of the insert 2 (i.e., the surface of the insert contacting the mail bin 1) may decrease the tendency of the insert 2 to move with respect to the mail bin 1.

Alternatively, the top of the base 20 may comprise a slip promoting surface. With a slip promoting surface, the bottom edge of the mail will tend to slip until it contacts either a support 21 or the wall of the bin 11, thus potentially decreasing the likelihood that mail 3 will fall or curl over itself.

To use the insert 2, a carrier places the insert 2 into a mail bin 1. The mail 3 can be sorted manually and/or automatically into carrier walk sequence and placed in the bin 1 such that the mail 3 is supported substantially vertically by the insert 2 as shown in FIG. 3. In one embodiment, flat mail and letters may both be sorted into a bin using the insert of the present invention, which would eliminate the need for mail carriers to pull letters from one bin and flat mail from another. At each address, the mail carrier can easily view the delivery addresses of the sorted mail and deliver the appropriate pieces. Once sorting and delivery are complete, the carrier can remove the insert 2 from the bin 1 and store the insert and/or the mail bin in a nested or partially nested configuration.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A mail sorting bin insert, comprising:
a bottom defining a substantially planar surface having a length and a width, wherein at least one of the length and the width substantially corresponds to at least one of a length and width of a standard mail bin; and
at least one support projecting upright from the bottom, wherein the support is sized and configured to support flat mail in a substantially vertical orientation.

2. The mail sorting bin insert of claim 1, wherein the insert comprises a lightweight material.

3. The mail sorting bin insert of claim 2, wherein the insert comprises a material selected from the group consisting of cardboard, plastic, wood, and composites.

4. The mail sorting bin insert of claim 1, wherein the insert comprises two supports.

5. The mail sorting bin insert of claim 4, wherein the bottom of the insert comprises three substantially coplanar sections which are separated from each other by the two supports, and wherein the two support have substantially triangular-shaped cross sections.

6. The mail sorting bin insert of claim 1, wherein the at least one support has a triangular-shaped cross section.

7. The mail sorting bin insert of claim 1, wherein the bottom and at least one support are created from a single piece of material.

8. The mail sorting bin insert of claim 7, wherein the at least one support is created by folding the single piece of material.

9. A mail sorting bin insert, comprising at least one substantially vertical section projecting from a substantially horizontal section, wherein the insert is sized and configured to receive flat mail from an automatic mail sorter and the at least one substantially vertical section is configured to support flat mail in a substantially vertical orientation.

10. The mail sorting bin insert of claim 9, wherein the insert comprises a lightweight material.

11. The mail sorting bin insert of claim 10, wherein the lightweight material is selected from the group consisting of cardboard, plastic, wood, and composites.

12. The mail sorting bin insert of claim 9, wherein the insert has two substantially vertical sections.

13. The mail sorting bin insert of claim 9, wherein the at least one substantially vertical section has a substantially triangular-shaped cross section.

14. The mail sorting bin insert of claim 9, wherein the insert has a length, and the length of the insert substantially corresponds to a length of a mail sorting bin.

15. The mail sorting bin insert of claim 9, wherein the insert comprises a single piece of material.

16. The mail sorting bin insert of claim 15, wherein the insert is folded to create the substantially vertical sections and substantially horizontal sections.

17. The mail sorting bin insert of claim 9, wherein the substantially vertical section has a height, and the height of the substantially vertical section approximates a height of a mail sorting bin.

18. The mail sorting bin insert of claim 9, wherein the insert comprises an anti-slip surface.

19. A mail sorting bin insert, comprising:
a base defining a substantially planar surface, wherein the base is sized to substantially cover a bottom surface of a mail sorting bin; and
a plurality of substantially vertical supports attached to the base, wherein each substantially vertical support has a triangular-shaped cross section sized and configured to support flat mail in a substantially vertical orientation, and wherein the insert is configured to permit automatic sorting of flat mail into carrier walk sequence.

20. A mail sorting tub insert, comprising a flat sheet, wherein the flat sheet includes a plurality of sections and a plurality of predefined fold lines, wherein two adjacent sections are separated by a predefined fold line, and wherein the predefined fold lines are arranged and configured such that when the flat sheet is folded at the predefined fold lines, the sheet forms a base and at least one upright support sized and configured to support flat mail in an upright orientation.

21. The mail sorting tub insert according to claim 20, wherein the flat sheet has an upper surface and a lower surface, and wherein at least one predefined fold line permits a first section to rotate with respect to an adjacent second section in one direction, and wherein at least one predefined fold line permits a third section to rotate with respect to an adjacent fourth section in the other direction.
